(19) United States
(12) Patent Application Publication
(10) Pub. No.: US 2008/0198389 A1
(43) Pub. Date: Aug. 21, 2008

(54) Outer and Inner Diameter Measuring Apparatus and Method for Transparent Tube

(75) Inventors: Won-Sang Yoo, Gyeonggi-do (KR); Sang-Joon Bae, Gyeonggi-do (KR); Young-Sun Kim, Seoul (KR); Young-Ghi Kim, Gyeonggi-do (KR); Young-Chang Cho, Gyeongsangbuk-do (KR)

Correspondence Address: JONES DAY, 222 EAST 41ST ST, NEW YORK, NY, 10017, US

(73) Assignee: LS CABLE LTD., Seoul (KR)

(21) Appl. No.: 11/813,807

(22) PCT Filed: May 27, 2005
(86) PCT No.: PCT/KR2005/001571

§ 371 Date: Mar. 13, 2008

(30) Foreign Application Priority Data
Jan. 13, 2005 (KR) 10 2005 0003422

(51) Int. Cl. G01B 11/00

(52) U.S. Cl. 356/626

(57) ABSTRACT

An outer and inner diameter measuring method for a transparent tube in a non-contact manner includes the steps of irradiating a light having a linear sectional shape, inclined at a pre-determined angle with respect to a plane perpendicular to a length direction of a transparent tube, to the transparent tube; obtaining a light beam pattern formed since the light having a linear sectional shape is intercepted and refracted by the tube; obtaining an inner diameter of the tube by extracting inner diameter information of the tube from the obtained light beam pattern; and obtaining an outer diameter from a light beam pattern refracted by the tube, thereby calculating the outer and inner diameters together.

### TECHNICAL FIELD

The present invention relates to apparatus and method for measuring inner and outer diameters of a transparent tube in a non-contact manner.

### BACKGROUND ART

There have been known various techniques for measuring an outer diameter of an object such as a tube or a cylinder in a non-contact manner as follows.

First, U.S. Pat. No. 5,015,867 discloses a technique for irradiating a laser beam oscillated from a laser diode to an object and then extracting outer diameter information based on patterns of a laser beam diffracted or interfered at edges of the object by using an optical system such as a lens or a camera. Second, U.S. Pat. No. 6,346,988 discloses a technique for irradiating a collimated parallel light to an object and then extracting a position where the parallel light is intercepted by the object in order to measure an outer diameter.

However, the first technique is suitable for measuring an outer diameter of an opaque object but not suitable for measuring an outer diameter of a transparent object.

In addition the second technique may measure an outer diameter of both transparent and opaque objects but not suitable for measuring an inner diameter similarly to the first technique.

Meanwhile, in MCVD (Modified Chemical Vapor Deposition) for making an optical fiber preform by depositing and sintering soot on an inner wall of a tube with blowing reaction gas into the transparent silica tube, it is required to check whether a silica layer deposited and sintered on the inner wall of the tube is evenly and suitably formed as desired along a length direction during the process. For this purpose, it is needed to measure an inner diameter of the silica tube as well as an outer diameter, so there is an urgent need for convenient and exact measuring method and apparatus.

Meanwhile, an inner diameter of a transparent tube or cylinder can be obtained in a way of measuring an outer diameter using the above first or second technique and then measuring a thickness at each point. For example, Korean Laid-open Patent Publication No. 2000-0011448 discloses a technique for irradiating a light beam with a modulated optical frequency to a transparent flat object, receiving interference signals of two light beams reflected from each surface of the object, and then measuring a path difference of two beams and a thickness using an oscillation frequency per a modulation period. However, in order to measure a thickness of a transparent tube or cylinder by applying this method, the thickness should be measured with turning around the transparent tube one time or rotating the transparent tube one time, so a measuring device is enlarged or complicated. In addition, this method may exactly measure a thickness not exceeding several times of the light beam wavelength, but an interference pattern cannot be easily recognized if a thickness of the tube gets thicker along with the progress of procedure, which makes it difficult to measure an actual thickness.

### DISCLOSURE OF INVENTION

### Technical Problem

The present invention is designed in consideration of the above problems, and therefore it is an object of the invention to provide apparatus and method for measuring inner and outer diameters of a transparent tube or cylinder in a convenient and easy way.

### Technical Solution

In order to accomplish the above object, the present invention irradiates a light beam to a transparent, and then extracts and calculates inner diameter information of the tube from a refracted pattern formed when the light beam passes through the tube, thereby obtaining an inner diameter.

That is to say, the inner and outer diameter measuring method for a transparent tube according to the present invention irradiates a light having a linear sectional shape and inclined at a predetermined angle with respect to a plane perpendicular to a length direction of the transparent tube toward the transparent tube and then obtains a light beam pattern intercepted and refracted by the tube, thereby capable of obtaining inner and outer diameters of the tube together from the light beam pattern.

Specifically, if a light having a linear sectional shape is irradiated to the transparent tube as mentioned above, a light beam pattern formed since the light beam having a linear sectional shape is intercepted by the transparent tube and a light beam pattern formed since the light beam passing through the transparent tube is refracted by the tube are formed. Among the obtained light beam patterns, outer diameter information is extracted from the light beam pattern intercepted by the tube, and inner diameter information is extracted from the light beam pattern refracted by the tube, thereby calculating the inner and outer diameters.

Meanwhile, the outer and inner diameter measuring apparatus for a transparent tube according to the present invention includes a light beam irradiating means for irradiating a light beam having a linear sectional shape and inclined at a predetermined angle with respect to a plane perpendicular to a length direction of a transparent tube; a pattern obtaining means arranged to face the light beam irradiating means with the tube being interposed therebetween so as to obtain a light beam pattern intercepted and refracted by the tube; and a calculating means for extracting inner diameter information of the tube from a pattern refracted by the tube among the light beam pattern obtained by the pattern obtaining means, and calculating and outputting an inner diameter of the tube.

In addition, the light beam irradiating means may include a laser beam generator; a linear light converting optical system for converting a laser beam, generated from the laser beam generator, into a light having a linear sectional shape; and a collimator for converting the laser beam, converted into the light having a linear sectional shape by the linear laser beam converting optical system, into a parallel linear light.

In addition, the pattern obtaining means may include a screen to which the pattern intercepted and refracted by the tube is projected; and a camera for photographing the light beam pattern projected to the screen.

In addition, the calculating means may additionally extract outer diameter information of the tube from a pattern intercepted by the tube among the light beam pattern obtained by the pattern obtaining means, and calculate and output an outer diameter of the tube.

As described above, the outer and inner diameter measuring apparatus and method for a transparent tube according to the present invention may measure outer and inner diameters of the transparent tube in a convenient and exact way using a non-contact manner by means of an optical method.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic view showing an apparatus for measuring inner and outer diameters of a transparent tube according to a preferred embodiment of the present invention;

FIG. 2 is a sectional view showing a screen having a light diffusion coating, employed in the apparatus of FIG. 1;

FIG. 3 is a perspective view showing a light beam pattern displayed on the screen in case a transparent tube to be measured is not positioned on a light path;

FIG. 4 is a perspective view showing a light beam pattern displayed on the screen in case the transparent to be measured is positioned on a light path;

FIG. 5 shows a path of a light having a linear sectional shape irradiated to a transparent tube, which is intercepted and refracted by the tube and then displayed on the screen as a light beam pattern, and a light beam pattern displayed on the screen;

FIG. 6 is a drawing for illustrating a refraction law appearing when a light beam passes through mediums with different refractive indexes; and

FIG. 7 is a drawing for illustrating a process of extracting inner diameter information of a transparent tube according to an embodiment of the present invention.

### BEST MODE FOR CARRYING OUT THE INVENTION

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

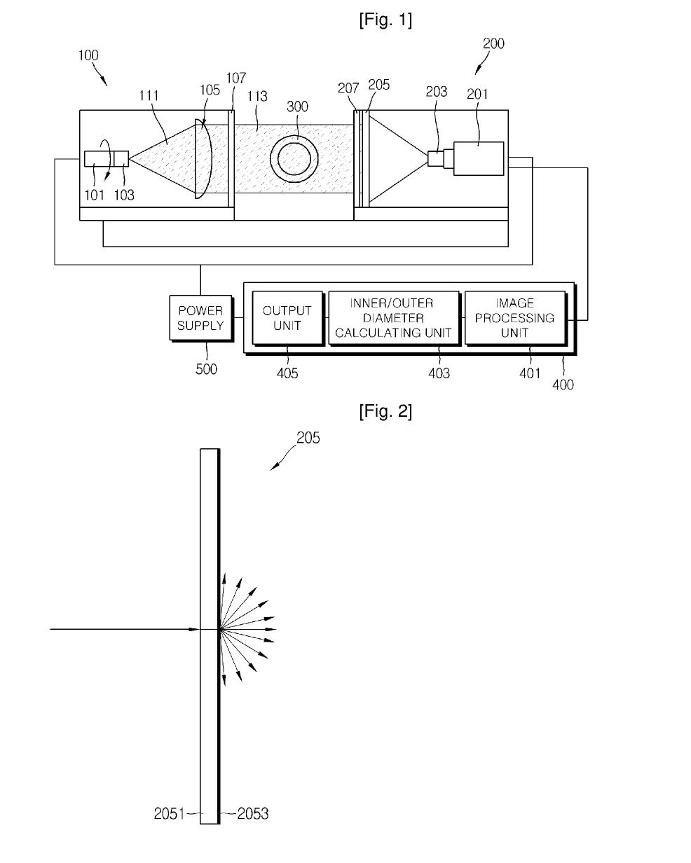

FIG. 1 schematically shows an apparatus for measuring inner and outer diameters of a tube according to a preferred embodiment of the present invention.

Referring to FIG. 1, the apparatus for measuring inner and outer diameters of a tube according to this embodiment includes a light beam irradiating means 100 and a pattern obtaining means 200 arranged to face each other so that a transparent tube 300 such as a silica tube, which will be an optical fiber preform, is interposed between them, an calculating means 400, and a power supply 500.

The light beam irradiating means 100 is a means for forming a laser beam used for measurement of inner and outer diameters of the tube 300 and then irradiating the laser beam to the tube 300. The light beam irradiating means 100 includes a laser beam generator 101, a linear light converting optical system 103, a collimator 105, and an IR (infrared) cutoff filter 107.

The laser beam generator 101 may use a semiconductor laser with a suitable output as a light source for sensor. The linear light converting optical system 103 is an optical system for converting a laser beam, output from the laser beam generator 101, into a light having a linear sectional shape perpendicular to an advancing direction of the laser beam. The linear light converting optical system 103 is composed of a beam diffusion lens (e.g., a concave lens or a convex lens), and/or an optical system such as a slit. The collimator 105 is a lens for focusing a laser beam 111, having a linear sectional shape and spreading at a predetermined angle, into a parallel light 113. The IR cutoff filter 107 is used for preventing damage of various optical systems and electronic parts caused by a high temperature during the process, and it is arranged to an output side of the light beam irradiating means 100. However, if heat is not generated or negligible, the IR cutoff filter may be excluded.

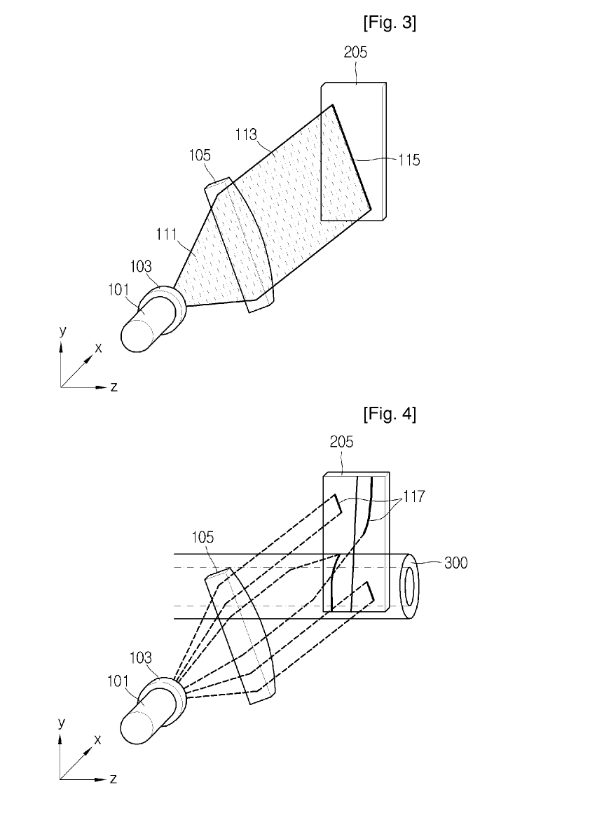

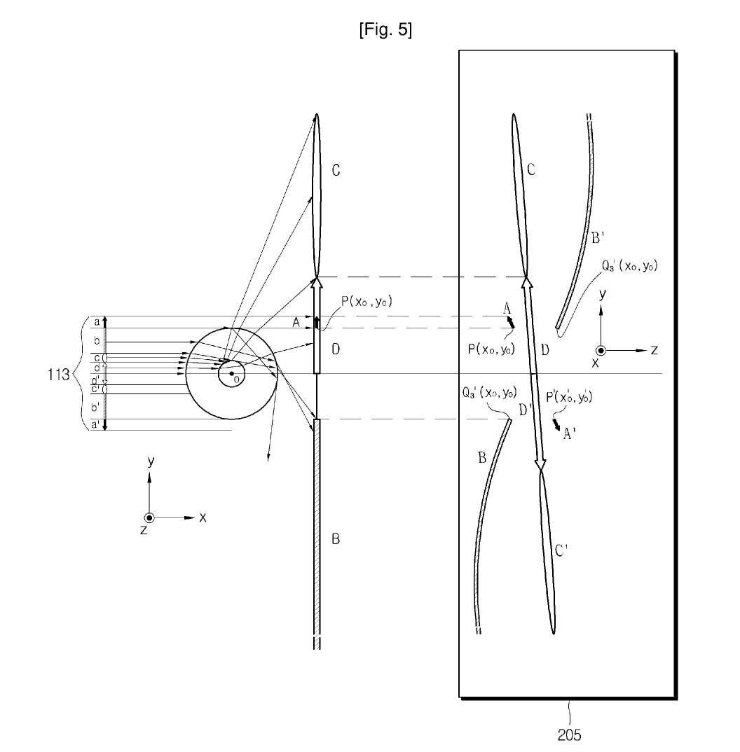

The light beam irradiating means 100 configured and arranged as mentioned above is constructed so that the laser beam 113 is irradiated in a direction perpendicular to the length direction of the transparent tube 300 to be measured. At this time, as shown in FIGS. 3 and 4, the laser beam 113 is arranged to be slightly inclined against a y-axis (e.g., 10 to 30 degrees). It prevents the light beam pattern 117 intercepted and refracted by the tube 300 from being overlapped with each other and thus not distinguished.

Meanwhile, it has been described above that the light beam irradiating means 100 uses a laser as a light source and includes the linear light converting optical system 103 and the collimator 105, but the inner and outer diameter measuring apparatus of the present invention is not limited thereto. For example, the light beam irradiating means 100 may use LED as a light source instead of laser, and the linear light converting optical system and/or the collimator may be excluded by using a plurality of light sources arranged in a straight array structure.

The pattern obtaining means 200 is a means for obtaining a light beam pattern 117, which is formed since the laser beam 113 irradiated from the light beam irradiating means 100 is intercepted and refracted by the tube 300. The pattern obtaining means 300 includes a camera 201, a band pass filter 203, a screen 205 and an IR cutoff filter 207.

The camera 201 generally adopts a CCD (Charge-Coupled Device) camera, but not limitedly. The band pass filter 203 is used for preventing a measured value from being changed due to surrounding lights aside from the light beam pattern on the screen 205 or white heat from the heated tube 300. The screen 205 gives a place to which the light beam pattern 117 intercepted or refracted when the laser beam 113 passes through the tube 300 is projected. The IR cutoff filter 207 is used for preventing damage of various optical systems and electronic parts caused by a high temperature during the process, similarly to the above IR cutoff filter 107, and this IR cutoff filter 207 is arranged at an input side of the pattern obtaining means 200. However, this IR cutoff filter can be excluded if heat is not specially generated or negligible depending on an object to be measured or surrounding circumstances.

Meanwhile, the screen 205 is preferably configured so that a pattern formed on a front side (e.g., a left side in FIG. 2) is uniformly diffused in all directions on a rear side as shown in FIG. 2, which may facilitate the camera 201 to easily photograph a pattern. In addition, though the IR cutoff filter 207 is provided, the screen 205 should endure a high temperature circumstance of 100° C. or above. For this purpose, the screen 205 preferably has a light diffusion coating 2053 containing opal or alumina, formed on a rear side of a glass plate 2051.

The calculating means 400 is a means for calculating and outputting inner and outer diameters of the tube 300 from the light beam pattern data obtained by the pattern obtaining means 200. The calculating means 400 includes an image processing unit 401, an inner and outer diameter calculating unit 403, and an output unit 405. The calculating means 400 may be all or partially configured with hardware or software, and also it may be realized using a common computer.

The image processing unit 401 quantizes or digitalizes pattern data transmitted as an analog signal from the camera 201, and converts the data to allow mathematic process in the inner and outer diameter calculating unit 403. The inner and outer calculating unit 403 is a module for actually calculating inner and outer diameters of t he tube 300 from the pattern data obtained from the image processing unit 401, which will be described in detail later. The output unit 405 displays information such as inner and outer diameters calculated by the inner and outer diameter calculating unit 403 on a display (not shown) so that a worker may recognize the information.

The power supply 500 supplies necessary power to electric and electronic parts such as the laser generator 101, the camera 201, the calculating means 400 and so on.

Subsequently, the operation of the inner and outer diameter measuring apparatus configured as mentioned above according to this embodiment is described for illustrating a method for measuring inner and outer diameters of a transparent tube according to the present invention.

If a power is applied to the measuring apparatus, a laser beam is generated from the laser generator 101, and this laser beam is converted into a light 111 having a linear sectional shape and spreading at a predetermined angle by means of the linear light converting optical system 103. The light 111 having a linear sectional shape is converted into a parallel light 113 having a linear sectional shape and advancing in parallel while passing through the collimator 105. Thus, in case no object to be measured exists on the path of the laser beam 113 as shown in FIG. 3, a linear pattern 115 is projected on the screen 205. Meanwhile, if the transparent tube 300 to be measured is positioned on the path of the laser beam 113 as shown in FIG. 4, a pattern 117 formed since the laser beam 113 is partially intercepted and refracted by the tube 300 is projected on the screen 205. The light beam pattern 117 projected on the screen 205 is photographed by the camera 201, and the photographed data is transmitted to the image processing unit 401. This data is processed into a pattern data by the image processing unit 401. The pattern data is transmitted to the inner and outer diameter calculating unit 403 and then calculated and output as inner and outer diameters of the tube 300, and this information is displayed by the display 405 so that a worker may recognize it.

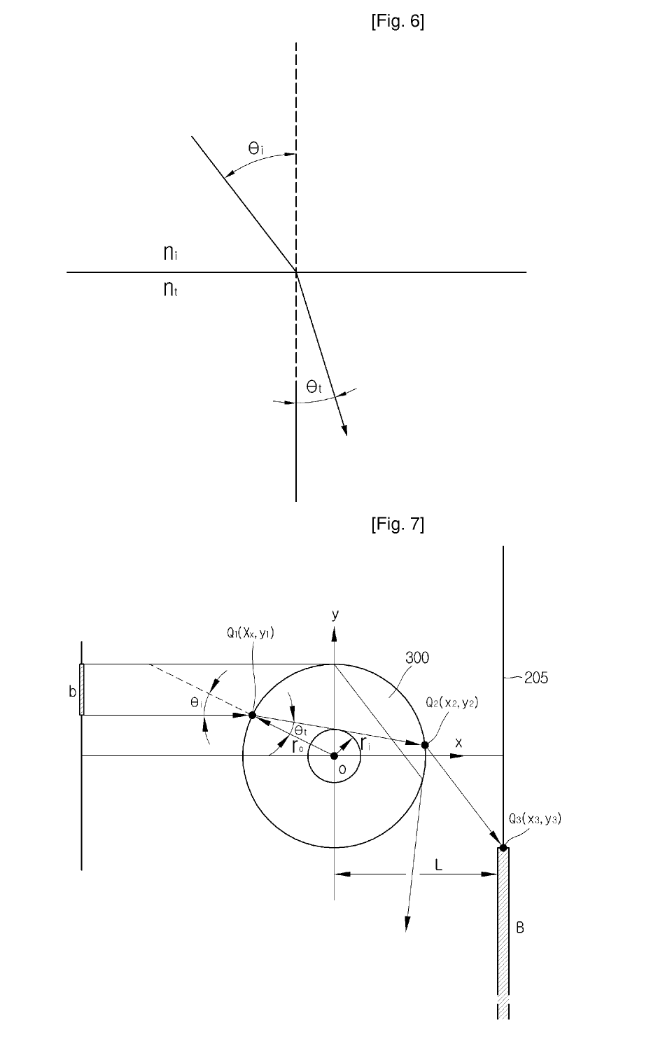

Hereinafter, the forming process and shapes of the light beam pattern 117 and the operation of the calculating means 400, particularly the inner and outer calculating unit 403, will be described in detail with reference to FIGS. 5 to 7.

FIG. 5 is a view for illustrating the specific forming mechanism of the light beam pattern 117 schematically shown in FIG. 4. A left portion of FIG. 5 is a view seen in a z-axis direction, namely in a length direction of the tube 300, and a right portion of FIG. 5 is a view showing a pattern projected on the screen 205 seen in a x-axis direction, namely in a direction perpendicular to the length direction of the tube 300. In FIG. 5, a, b, c, d, a′, b′, c′ and d′ denote the laser beam 113 having a linear sectional shape in a classified pattern for the convenience of description, and A, B, C, D, A′, B′, C′ and D′ respectively denote patterns formed in correspondence to a, b, c, d, a′, b′, c′ and d′. Meanwhile, advancing paths of the laser beam a′, b′, c′ and d′ are not specially shown, but they are respectively symmetric to advancing paths of a, b, c and d. In addition, x and y coordinate values of each point P, P′, Q₃ or Q₃′ are respectively coordinates when defining a center O of the tube 300 as the origin. Here, a z coordinate value of each point P, P′, Q₃ or Q₃′ is not displayed since the z coordinate value does not contribute to extraction of inner and outer diameter information and calculation of the inner and outer diameters, described later.

Referring to FIG. 5, an entire length of the laser beam 113 is slightly longer than an outer diameter of the tube 300, and the laser beam a and a′ out of the outer diameter of the tube passes as it is and is then projected on the screen 205 as patterns A and A′. The laser beam b and b′ is refracted twice with passing through the tube 300, and it is projected on the screen 205 as patterns B and B′. In addition, the laser beam c and c′ is refracted once with advancing into the tube 300, reflected on the inner circumference of the tube, refracted once again with departing from the tube, and then projected on the screen 205 as patterns C and C′. Finally, the laser beam d and d′ is refracted four times in total with passing through the tube 300, and is then projected on the screen 205 as patterns D and D′. At this time, since the laser beam 113 is inclined at a pre-determined angle with respect to the y-axis as mentioned above, each pattern A, B, C, D, A′, B′, C′ or D′ are not overlapped with each other, and separately shown in a symmetric shape as shown in the right portion of FIG. 5.

In the pattern shown in FIG. 5, the outer diameter information is extracted form the patterns A and A′. That is to say, the patterns A and A′ formed by the beam a and a′ beyond the outer diameter of the tube among the entire laser beam 113 show the outer diameter of the tube as they are, so a difference of y coordinate values of both end points P and P′ of the patterns A and A′ becomes an outer diameter value of the tube as it is. That is to say, the outer diameter value of the tube 300 is directly obtained from the separate patterns A and A′ formed since the laser beam 113 is intercepted by the tube.

Dₒ=2rₒ=|yₒ−yₒ′|=2yₒ Equation 1

Here, Dₒ and rₒ are respectively an outer diameter and an outer radius of the tube 300.

Meanwhile, the inner diameter information of the tube 300 is obtained from the separate patterns B and B′ formed by the beam that is refracted with passing through the tube, but this inner diameter information is obtained through a relatively complicated process in comparison to the outer diameter information. The process of extracting inner diameter information of a tube and calculating an inner diameter is specifically described below.

First, extraction of the inner diameter information starts from understanding on the refraction phenomenon. In case a light passes through a boundary of mediums having different refractive indexes nᵢ and nₜ, the light passes with a refraction angle θₜ with respect to an incidence angle θᵢ. At this time, the following relation is established between the incidence angle θᵢ and the refraction angle θₜ (Snell's law).

$$\frac{{n}_{i}}{{n}_{t}} = \frac{sin {θ}_{t}}{sin {θ}_{i}} \qquad Equation 2$$

Based on the Snell's law, assuming that an outer radius of the tube 300 is rₒ and an inner radius is rᵢ, an incidence point Q₁ and an output point Q₂ of the laser bam projected to an end point Q₃ of the pattern B toward/from the tube, and a projection point Q₃ onto the screen 205 respectively have coordinates calculated as explained below. Hereinafter, qᵢ and qₜ respectively denote an incidence angle and a refraction angle of the laser beam b that is input to the incidence point Q₁, and nᵢ and nₜ respectively denote a refractive index (=1) in the air and a refractive index in the transparent tube 300.

$$\begin{matrix}{y}_{1} = \frac{{n}_{t}}{{n}_{i}} {r}_{i} \\ {x}_{1} = - {r}_{o} cos {θ}_{i} & Equation 3 \\ \begin{matrix}{y}_{2} = {y}_{1} - 2 \sqrt{{r}_{o}^{2} - {r}_{i}^{2}} sin ( {θ}_{i} - {θ}_{t} ) \\ = \frac{{n}_{t}}{{n}_{i}} {r}_{i} - 2 \sqrt{{r}_{o}^{2} - {r}_{i}^{2}} sin ( {θ}_{i} - {θ}_{t} )\end{matrix} \\ \begin{matrix}{x}_{2} = {x}_{1} + 2 \sqrt{{r}_{o}^{2} - {r}_{i}^{2}} cos ( {θ}_{i} + {θ}_{t} ) \\ = - {r}_{o} cos {θ}_{i} + 2 \sqrt{{r}_{o}^{2} - {r}_{i}^{2}} cos ( {θ}_{i} - {θ}_{t} )\end{matrix} & Equation 4 \\ {x}_{3} = L \\ \begin{matrix}{y}_{3} = {y}_{2} - ( {x}_{3} - {x}_{2} ) tan 2 ( {θ}_{i} - {θ}_{t} ) \\ = \frac{{n}_{t}}{{n}_{i}} {r}_{i} - 2 \sqrt{{r}_{o}^{2} - {r}_{i}^{2}} sin ( {θ}_{i} - {θ}_{t} ) - \\ ( L + {r}_{o} cos {θ}_{i} - 2 \sqrt{{r}_{o}^{2} - {r}_{i}^{2}} cos ( {θ}_{i} - {θ}_{t} ) ) tan 2 ( {θ}_{i} - {θ}_{t} )\end{matrix} & Equation 5\end{matrix}$$

Meanwhile, θᵢ and θₜ are expressed using the following equation.

$${θ}_{t} = {sin}^{- 1} \frac{{r}_{i}}{{r}_{o}} \\ {θ}_{i} = {sin}^{- 1} \frac{{n}_{t} {r}_{i}}{{n}_{i} {r}_{o}} \qquad Equation 6$$

In addition, nᵢ, nₜ and L are already known values, and rₒ is a value obtained from the equation 1. In addition, y₃ is a value obtained from the pattern data acquired by the camera 201. Thus, if putting the equation 6 into the equation 5, the inner radius r of the tube can be obtained and the inner diameter value Dᵢ of the tube can be obtained.

In other cases, it is also possible to configure an approximate equation for the inner radius rᵢ in multi degrees and multi terms and then putting the y coordinate value y₃ of the projection point Q₃ on the screen 205 to the approximate equation so as to calculate the inner radius rᵢ. At this time, coefficients a₀, a₁, aₙ of each term in the following approximate equation can be obtained through correction of an object whose inner radius is already known.

rᵢ=a₀+a₁y₃+, . . . , +aₙy₃ⁿ Equation 7

According to this embodiment, it is possible to exactly obtain an inner diameter of a transparent tube as well as an outer diameter in a non-contact manner. Thus, if this embodiment is applied to an optical fiber preform manufacturing process, the outer and inner diameters of a tube in a high temperature white-hot state can be measured frequently or in real time, so process conditions can be controlled to make the inner and outer diameters uniform in a length direction during the optical fiber preform manufacturing process, thereby providing an optical fiber preform having further improved quality. However, the present invention is not limitedly applied to the optical fiber preform manufacturing process, but it can be applied to any object if the object is a transparent tube or cylinder.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

According to the present invention, exact outer and inner diameters of a tube or cylinder can be obtained together from a light beam pattern formed since a light beam irradiated to the transparent tube or cylinder is intercepted and bent by the tube or cylinder. Thus, in case the present invention is particularly applied to an optical fiber preform manufacturing process, inner and outer diameters of the tube that will become an optical fiber preform can be measured frequently or in real time during the manufacturing process, thereby making it possible to give a high-quality optical fiber preform.

1. An outer and inner diameter measuring apparatus for a transparent tube, comprising:
a light beam irradiating means for irradiating a light having a linear sectional shape and inclined at a predetermined angle with respect to a plane perpendicular to a length direction of a transparent tube;
a pattern obtaining means arranged to face the light beam irradiating means with the tube being interposed therebetween so as to obtain a light beam pattern intercepted and refracted by the tube; and
a calculating means for extracting inner diameter information of the tube from a pattern refracted by the tube among the light beam pattern obtained by the pattern obtaining means, and calculating and outputting an inner diameter of the tube.

2. The outer and inner diameter measuring apparatus for a transparent tube according to claim 1, wherein the light beam irradiating means includes:
a laser beam generator;
a linear light converting optical system for converting a laser beam, generated from the laser beam generator, into a light having a linear sectional shape; and
a collimator for converting the laser beam, converted into the light having a linear sectional shape by the linear laser beam converting optical system, into a parallel linear light.

3. The outer and inner diameter measuring apparatus for a transparent tube according to claim 1 or 2, further comprising an IR (infrared) cutoff filter arranged to a light beam output side of the light beam irradiating means.

4. The outer and inner diameter measuring apparatus for a transparent tube according to claim 1, wherein the pattern obtaining means includes:
a screen to which the pattern intercepted and refracted by the tube is projected; and
a camera for photographing the light beam pattern projected to the screen.

5. The outer and inner diameter measuring apparatus for a transparent tube according to claim 1 or 4, further comprising an IR cutoff filter arranged to a light beam input side of the pattern obtaining means.

6. The outer and inner diameter measuring apparatus for a transparent tube according to claim 4, further comprising a band pass filter provided between the screen and the camera.

7. The outer and inner diameter measuring apparatus for a transparent tube according to claim 4, wherein the screen has a light diffusion coating.

8. The outer and inner diameter measuring apparatus for a transparent tube according to claim 1,
wherein the calculating means additionally extracts outer diameter information of the tube from a pattern intercepted by the tube among the light beam pattern obtained by the pattern obtaining means, and calculates and outputs an outer diameter of the tube.

9. An outer and inner diameter measuring method for a transparent tube, comprising:
irradiating a light having a linear sectional shape and inclined at a predetermined angle with respect to a plane perpendicular to a length direction of a transparent tube, to the transparent tube;
obtaining a light beam pattern formed since the light having a linear sectional shape is intercepted and refracted by the tube; and
obtaining an inner diameter of the tube by extracting inner diameter information of the tube from the obtained light beam pattern.

10. The outer and inner diameter measuring method for a transparent tube according to claim 9,
wherein, in the inner diameter obtaining step, the inner diameter information is extracted from a pattern refracted by the tube among the obtained light beam pattern.

11. The outer and inner diameter measuring method for a transparent tube according to claim 10,
wherein, in the inner diameter obtaining step, the inner diameter is calculated by putting a coordinate value of the refracted pattern to an approximate equation for the inner diameter expressed by an equation of multi degrees and multi terms.

12. The outer and inner diameter measuring method for a transparent tube according to claim 9, further comprising:
extracting outer diameter information of the tube from the obtained light beam pattern, and then obtaining an outer diameter of the tube.

13. The outer and inner diameter measuring method for a transparent tube according to claim 12,
wherein, in the outer diameter obtaining step, the outer diameter information is extracted from a pattern intercepted by the tube among the obtained light beam pattern.
